(19) United States
(12) Patent Application Publication
(10) Pub. No.: US 2007/0224367 A1
(43) Pub. Date: Sep. 27, 2007

(54) Mold multilayered sheet for use as a diffuser in flat screens

(76) Inventors: Claus Rudiger, Krefeld (DE); Jurgen Rohner, Koln (DE); Tanja Gruter-Reetz, Krefeld (DE); Klaus Kraner, Solingen (DE)

Correspondence Address: BAYER MATERIAL SCIENCE LLC, 100 BAYER ROAD, PITTSBURGH, PA, 15205, US

(21) Appl. No.: 11/726,053

(22) Filed: Mar. 21, 2007

(30) Foreign Application Priority Data
Mar. 24, 2006 (DE) 102006014118.0

(51) Int. Cl. C09K 19/00; G02F 1/1335

(52) U.S. Cl. 428/1.1; 428/1.5; 349/64

(57) ABSTRACT

A multilayer sheet suitable for use as a diffuser in flat screens is disclosed. The sheet includes at least one base layer (B) and at least one outer layer (A) wherein (B) comprise a transparent thermoplastics material and transparent polymeric particles, with the proviso that the refractive index of the material and particles differ one from the other, and wherein said (A) comprise a transparent polycarbonate and a bismalonate UV absorber.

### FIELD OF THE INVENTION

The present invention relates to a multilayer sheet for and in particular to a sheet useful as a diffuser in flat screens.

### TECHNICAL BACKGROUND OF THE INVENTION

Light-diffusing translucent products of polycarbonate with various light-diffusing additives and molded parts produced therefrom are known.

Thus, for example, EP-A 634 445 discloses light-dispersing compositions, which contain polymeric particles based on vinyl acrylate with a core/shell morphology in combination with TiO₂.

The use of light-diffusing polycarbonate films in flat screens is described in U.S. 2004/0066645. Mentioned here as light-diffusing pigments are polyacrylates, PMMA, polytetrafluoroethylenes, polyalkyltrialkoxysiloxanes and mixtures of these components.

JP 09311205 describes the use of polycarbonate (PC)/(poly(4-methyl-1-pentene)-blends as a matrix material for diffusers in backlight units.

JP 03078701 describes light-diffusing PC sheets, which have calcium carbonate and titanium dioxide as diffusing pigments and have a light transmitting capacity of about 40%.

Light-diffusing PC sheets with diffusing pigments of silica are described in JP 05257002.

PC sheets with diffusing pigments of polyorganosiloxanes are described in JP 10046022.

Two-layer sheets described in JP 08220311 include a diffuser coextrusion layer of 5 to 25 μm, which contains acrylic diffusing pigments and a base layer. The diffusing pigments used in this case have a size of 0.1 to 20 μm.

JP 10046018 disclosed a light diffusing resin composition that is obtained by blending aromatic polycarbonate resin with beady cross-linked acrylic resin. The particle diameter of the beady crosslinked acrylic resin is preferably 1-10 microns.

A PC sheet having an embossed corrugated structure applied during the extrusion is disclosed in JP 09011328.

PC diffuser sheets are described in JP 2004/029091, which contain 0.3 to 20% diffusing pigment and 0.0005 to 0.1% optical brighteners.

### SUMMARY OF THE INVENTION

A multilayer sheet suitable for use as a diffuser in flat screens is disclosed. The sheet includes at least one base layer (B) and at least one outer layer (A) wherein (B) comprise a transparent thermoplastics material and transparent polymeric particles, with the proviso that the refractive index of the material and particles differ one from the other, and wherein said (A) comprise a transparent polycarbonate and a bismalonate UV absorber.

### DETAILED DESCRIPTION OF THE INVENTION

The multilayer solid sheet according to the invention is distinguished by high color stability over a prolonged period of time with simultaneously undiminished luminance (brightness) during operation of the flat screen.

In order to assess the suitability of the light-diffusing sheets for what are known as backlight units for LCD flat screens, the brightness, in particular, of the total system has to be considered, in other words of the total BLU, not only the diffuser sheets per se. The diffuser sheets known from the prior art have unsatisfactory color stability with a simultaneously high brightness.

Basically, a backlight unit (direct light system) has the structure described below. It generally consists of a housing, in which a varying number of fluorescent tubes, known as CCFLs (cold cathode fluorescent lamps) are arranged, depending on the size of the backlight unit. The interior of the housing is equipped with a light-reflecting surface. The diffuser sheet, which has a thickness of 1 to 3 mm, preferably a thickness of 2 mm, rests on this lighting system. Located on the diffuser sheet is a set of films, which may have the following functions: light diffusion (diffuser films), circular polarizers, focusing of the light in the forward direction by what is known as BEF (brightness enhancing film) and linear polarizers. The linearly polarizing film rests directly below the LCD display located thereabove.

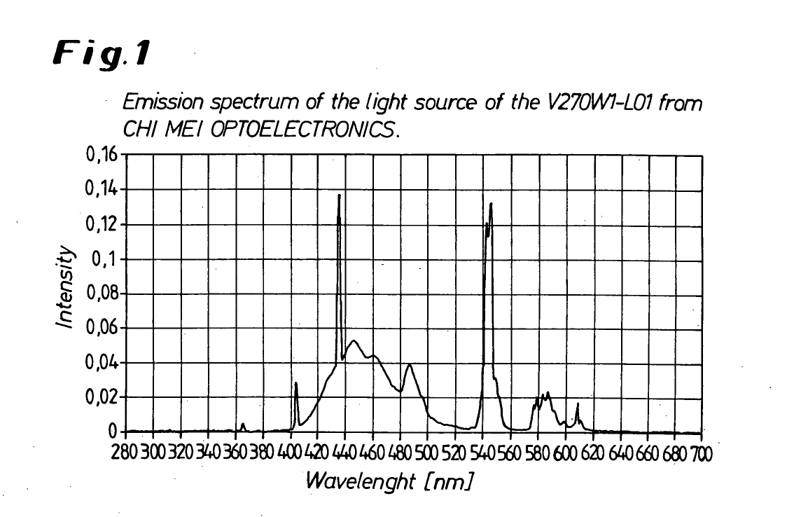

The CCFLs used in backlight units generally have a spectrum which shows emissions in the UV range. Although the intensity of the radiation emitted in the wavelength range <400 nm is relatively low compared to the intensity of the radiation >400 nm emitted in the visible range, this UV radiation may nevertheless lead to damage of the polymer matrix of the diffuser sheet over a long service life of the backlight unit which is shown by a yellowing of the material (FIG. 1: emission spectrum of the light source of the V270W1-L01 from CHI MEI OPTOELECTRONICS).

FIG. 1 shows the emission spectrum of the V270W1-L01 from Chi Mei Optoelectronics. This spectrum shows a very small emission peak at 315 nm and a small emission peak at 365 nm. These peaks are produced from the mercury vapor discharge of the fluorescent tubes used. The color composition of the light in fluorescent tubes is substantially determined by the composition of the coating of the glass, but partly also by the primary emission lines of the gas filling and its passage through the fluorescent material and the glass. The coating consists of phosphorus and metals of rare earths (lanthanoids).

It has now been found that the very small peak at 315 nm and the small peak at 365 nm may lead to substantial yellowing of the polycarbonate diffuser sheet employed during long term use (30,000 h) of a flat screen.

The above problem was found to be addressed by the inventive multilayered sheet that includes (B) a base layer that comprise a mixture of 80 to 99.99 percent relative to the weight of the mixture of transparent thermoplastics material and 0.01 to 20 percent relative to the weight of the mixture t of a transparent polymeric particles the refractive indices of said material and said particles differ one from the other, and an outer layer (A) that contains 90 to 99 percent relative to the weight of the outer layer of a transparent polycarbonate resin and 1 to 10 percent relative to the weight of the outer layer of a UV absorber conforming to formula (I)

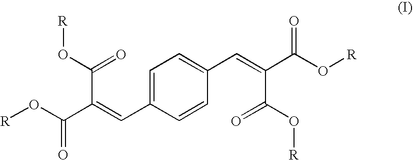

wherein R represents alkyl preferably C₁-C₆ alkyl, in particular C₁-C₄ alkyl, particularly preferably ethyl.

The present invention is based on the finding that UV absorbers of the bismalonate class conforming to formula (I) have a surprisingly high luminance (brightness) with simultaneously unchanged good UV protection compared to the UV light emitted by the CCFLs. Further UV absorbers may be added. Suitable additional UV absorbers include:

a) benzotriazole derivates conforming to formula (II)

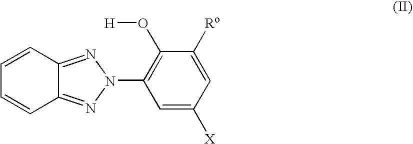

In formula (II) R⁰ and X are the same or different and represent H or alkyl or alkylaryl.

Preferred in this case is Tinuvin® 329 where X=1,1,3,3-tetramethylbutyl and R⁰═H

Tinuvin® 350 where X=tert.-butyl and R⁰=2-butyl

Tinuvin® 234 where X and R⁰=1,1-dimethyl-1-phenyl

b) dimeric benzotriazole derivatives conforming to formula (III)

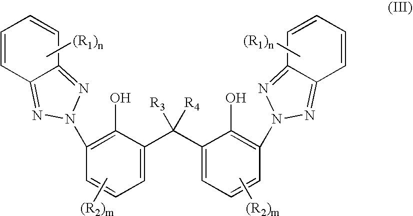

In formula (III) R¹ and R² are the same or different and represent H, halogen, C₁-C₁₀ alkyl, C₅-C₁₀ cycloalkyl, C₇-C₁₃ arylkyl, C₆-C₁₄ aryl, —OR⁵ or —(CO)—O—R⁵ where R⁵═H or C₁-C₄ alkyl.

In formula (III) R³ and R⁴ are also the same or different and represent H, C₁-C₄ alkyl, C₅-C₆ cycloalkyl, benzyl or C₆-C₁₄ aryl.

In formula (III) m represents 1, 2 or 3 and n 1, 2, 3 or 4.

Preferred in this case is Tinuvin® 360 where R¹═R³═R⁴═H; n=4; R²=1,1,3,3-tetramethylbutyl; m=1.

b1) dimeric benzotriazole derivatives according to formula (IV)

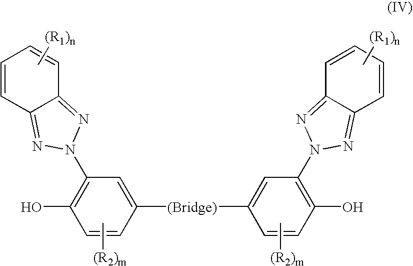

wherein the bridge represents

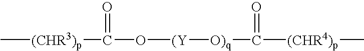

R¹, R², m and n have the meaning given for formula (III), and wherein p is an integer from 0 to 3,

q is an integer from 1 to 10, Y is —CH₂—CH₂—, —(CH₂)₃—, —(CH₂)₄—, —(CH₂)₅—, —(CH₂)₆—, or is CH(CH₃)—CH₂—and R³ and R⁴ have the meaning given for formula (III).

Preferred in this case is Tinuvin® 840 where R¹═H; n=4; R²=tert.-butyl; m=1; R² is provided in the ortho position with respect to the OH group; R³═R⁴═H; p=2; Y═—(CH₂)₅—; q=1.

c) triazine derivatives according to formula (V)

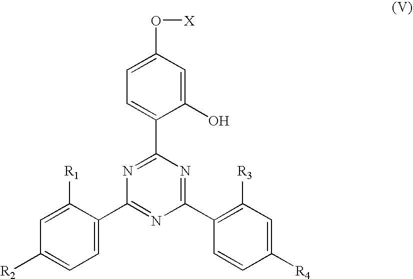

wherein R¹, R², R³, R⁴ are the same or different and are H, alkyl, CN or halogen and X is alkyl.

Preferred in this case is Tinuvin® 1577 where R¹═R²═R³═R⁴═H; X=hexyl and

Cyasorb® UV-1164 where R¹═R²═R³═R⁴=methyl; X=octyl.

d) triazine derivatives of the following formula (Va)

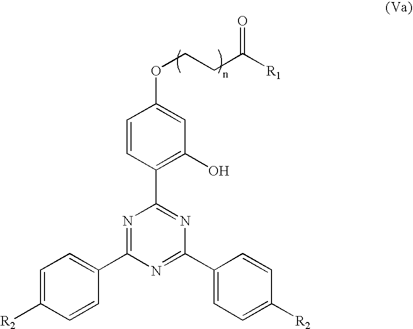

wherein

R¹ represents C₁ alkyl to C₁₇ alkyl,

R² represents H or C₁ alkyl to C₄ alkyl and

n is 0 to 20.

e) dimeric triazine derivatives of the formula (VI)

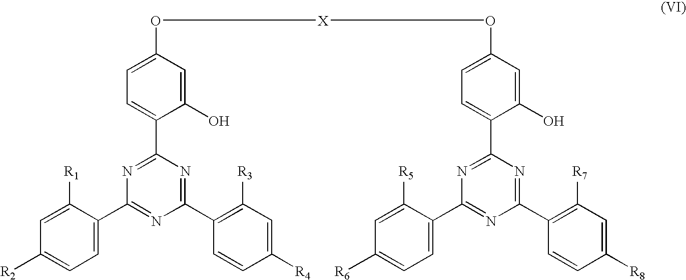

wherein

R¹, R², R³, R⁴, R⁵, R⁶, R⁷, R⁸ may be the same or different and represent H, alkyl, CN or halogen and

X is alkylidene, preferably methylidene or —(CH₂CH₂—O—)n-C(═O)— and n represents 1 to 10, preferably 1 to 5, in particular 1 to 3.

f) diarylcyanoacrylates of formula (VII)

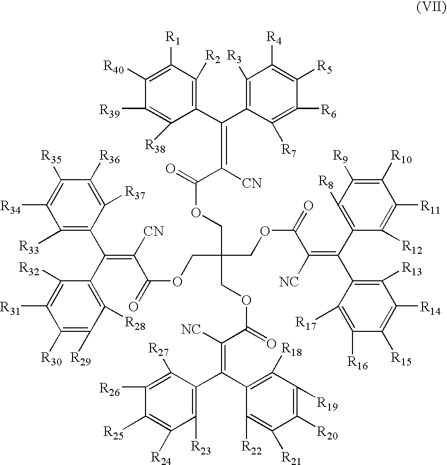

wherein R¹ to R⁴⁰ may be the same or different and represent H, alkyl, CN or halogen.

Preferred in this case is Uvinul® 3030 where R¹ to R⁴⁰═H.

Suitable transparent thermoplastics materials B1 for the production of the molded articles according to the invention are, for example polycarbonates, copolyester carbonates, polyesters, copolyesters, blends of polycarbonate and polyesters or copolyesters, polymethyl methacrylate, polyethyl methacrylate, styrene-acrylonitile copolymer or mixtures thereof; Polycarbonate, copolyester carbonates, polyesters, copolyesters, transparent blends of polycarbonate and polyesters or copolyesters are preferred; polycarbonates are particularly preferred.

Suitable polycarbonates for the production of the multilayer products according to the invention are all known aromatic polycarbonates. These are homopolycarbonates, copolycarbonates and thermoplastic polyester carbonates.

The suitable polycarbonates have weight average molecular weights ( M̅_{W}) of 15,000 to 40,000, preferably from 15,000 to 21,000 and, in particular, from 17,000 to 20,000, determined by measuring the relative solution viscosity in dichloromethane or in mixtures with the same quantities by weight of phenol/o-dichlorobenzene calibrated by light diffusion.

For the production of polycarbonates, reference is made by way of example to “Schnell, Chemistry and Physics of Polycarbonates, Polymer Reviews, Vol. 9, Interscience Publishers, New York, London, Sydney 1964”, and to “D.C. PREVORSEK, B. T. DEBONA and Y. KESTEN, Corporate Research Center, Allied Chemical Corporation, Moristown, N.J. 07960, ‘Synthesis of Poly(ester)carbonate Copolymers’ in Journal of Polymer Science, Polymer Chemistry Edition, Vol. 19, 75-90 (1980)”, and to “D. Freitag, U. Grigo, P. R. Müller, N. Nouvertne, BAYER AG, ‘Polycarbonates’ in Encyclopedia of Polymer Science and Engineering, Vol. 11, Second Edition, 1988, pages 648-718” and finally to “Dres. U. Grigo, K. Kircher and P. R. Müller ‘Polycarbonate’ in Becker/Braun, Kunststoff-Handbuch, Vol. 3/1, Polycarbonate, Polyacetale, Polyester, Celluloseester, Carl Hanser Verlag München, Wien 1992, pages 117-299”.

Polycarbonates are preferably produced by the phase interface method or the melt-transesterification method and will be described hereinafter by way of example using the phase interface method.

Compounds which are preferably used as the starting compounds are aromatic dihydroxy compounds of the general formula (VIII)
HO-Z-OH (VIII)

wherein

Z is a divalent organic radical with 6 to 30 carbon atoms, which contains one or more aromatic groups.

Examples of such compounds are bisphenols, which belong to the group of dihydroxydiphenyls, bis(hydroxyphenyl)alkanes, indane bisphenols, bis(hydroxyphenyl)ethers, bis(hydroxyphenyl)-sulphones, bis(hydroxyphenyl)ketones and α,α′-bis(hydroxyphenyl)-diisopropylbenzenes.

Particularly preferred bisphenolsare bisphenol-A, tetraalkylbisphenol-A, 4,4-(meta-phenylenediisopropyl) diphenol (bisphenol M), 4,4-(para-phenylenediisopropyl)-diphenol, 1,1-bis-(4-hydroxyphenyl)-3,3,5-trimethylcyclohexane (bisphenol-TMC) and mixtures thereof.

The aromatic dihydroxy compounds used according to the invention are preferably reacted with carbon dioxide compounds, in particular phosgene or reacted in the melt-transesterification process with diphenyl carbonate or dimethyl carbonate.

Polyester carbonates are preferably obtained by reacting the aforementioned aromatic dihydroxy compounds, at least one aromatic dicarboxylic acid and optionally carbon dioxide equivalents. Suitable aromatic dicarboxylic acids are, for example phthalic acid, terephthalic acid, isophthalic acid, 3,3′-or 4,4′-diphenyldicarboxylic acid and benzophenonedicarboxylic acids. A part up to 80 mol % preferably from 20 to 50 mol % of the carbonate groups in the polycarbonates may be replaced by aromatic dicarboxylic acid ester groups.

Inert organic solvents used in the phase interface method are, for example, dichloromethane, the various dichloromethanes and chloropropane compounds, tetrachloromethane, trichloromethane, chlorobenzene and chlorotoluene, chlorobenzene or dichloromethane or mixtures of dichloromethane and chlorobenzene preferably being used.

The phase interface reaction may be accelerated by catalysts such as tertiary amines, in particular N-alkylpiperidines or onium salts. Tributylamine, triethylamine and N-ethylpiperidine are preferably used. In the case of the melt-transesterification process, the catalysts mentioned in DE-A 42 38 123 are preferably used.

The polycarbonates may be branched deliberately and in a controlled manner by the use of small quantities of branching agents. Suitable branching agents include: phloroglucin, 4,6-dimethyl-2,4,6-tri-(4-hydroxyphenyl)-heptene-2; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; α,α′,α″-tris-(4-hydroxyphenyl)-1,3,5-triisopropylbenzene; 2,4-dihydroxybenzoic acid; trimesic acid; cyanurochloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1-tri-(4-hydroxyphenyl)-ethane and bis-(3-methyl-4-hydroxyphenyl)-2-oxo-2,3-dihydroindole.

0.05 to 2 mol % (relative to the amount of aromatic dihydroxy compounds )of branching agents or mixtures of branching agents to also optionally be used, may be used together with the aromatic dihydroxy compounds or in the alternative be added at a later stage of the synthesis.

Preferably used as chain terminators are phenols such as phenol, alkyl phenols such as cresol and 4-tert.-butylphenol, chlorophenol, bromophenol, cumylphenol or mixtures thereof used in quantities of 1 to 20 mol % preferably 2 to 10 mol % per mol of aromatic dihydroxy compounds. Phenol, 4-tert.-butylphenol or cumylphenol are preferred.

Chain terminators and branching agents may be added separately or together with the bisphenol to the syntheses.

The production of polycarbonates by the melt-transesterification process is described by way of example in DE-A 42 38 123.

Preferred polycarbonates according to the invention are the homopolycarbonate based on bisphenol A, the homopolycarbonate based on 1,1 -bis-(4-hydroxyphenyl)-3,3,5-trimethylcyclohexane and copolycarbonates based on the two monomers bisphenol A and 1,1-bis-(4-hydroxyphenyl)-3,3,5-trimethylcyclohexane and copolycarbonates based on the two monomers bisphenol A and 4,4′-dihydroxydiphenyl (DOD).

The homopolycarbonate based on bisphenol A is particularly preferred.

The polymeric particles B2 to be used according to the invention, with the refractive index, which is different from the matrix material, are, for example and preferably, those based on acrylate with a core-shell morphology, such as is disclosed in EP-A 634 445.

The polymeric particles B2 have a core of a rubbery vinyl polymer. The rubbery vinyl polymer may be a homopolymer or copolymer of any one of the monopolymers which have at least one ethylenically unsaturated group and which, as known to the person skilled in the art, undergo addition polymerization under the conditions of emulsion polymerization in an aqueous medium. Such monomers are listed in U.S. Pat. No., 4,226,752, column 3, lines 40 to 62 (incorporated herein by reference).

The rubbery vinyl polymer B2 preferably contains 15% by weight to 100%, more preferably at least 25 to 100% most preferably at least 40 to 100% by weight relative to the weight of B2 of a polymerized acrylate, methacrylate, monovinylarene or optionally substituted butadiene and 0 to 85% more preferably 0 to 75%, most preferably 0 to 60% by weight relative to the weight of B2 of one or more copolymerized vinyl monomers.

Preferred acrylates and methacrylates are alkyl acrylates or alkyl methacrylates, which preferably contain 1 to 18, particularly preferably 1 to 8, most preferably 2 to 8 carbon atoms in the alkyl group, such as methyl, ethyl, n-propyl, isopropyl, n-butyl, sec.-butyl or tert.-butyl or hexyl, heptyl or octyl groups. The alkyl group may be branched or linear. The preferred alkyl acrylates are ethyl acrylate, n-butyl acrylate, isobutyl acrylate or 2-ethylhexyl acrylate. The most preferred alkyl acrylate is butyl acrylate.

Other suitable acrylates are, for example, 1,6-hexanediol diacrylate, ethylthioethyl methacrylate, isobornyl acrylate, 2-hydroxyethyl acrylate, 2-phenoxyethyl acrylate, glycidyl acrylate, neopentylglycol diacrylate, 2-ethoxyethyl acrylate, t-butylaminoethyl methacrylate, 2-methoxyethyl acrylate, glycidyl methacrylate or benzyl methacrylate.

Preferred monovinylarenes are styrene or a-methylstyrene, optionally substituted at the aromatic ring with an alkyl group, such as methyl, ethyl or tertiary butyl or with a halogen, such as chlorine.

If substituted, the butadiene preferably has one or more alkyl groups, which contain 1 to 6 carbon atoms, or one or more halogens, most preferably one or more methyl groups and/or one or more chlorine atoms. Preferred butadienes are 1,3-butadiene, isoprene, chlorobutadiene or 2,3-dimethyl- 1,3-butadiene.

The rubbery vinyl polymer may contain one or more (co)polymerized acrylates, methacrylates, monovinylarenes and/or optionally substituted butadienes. These monomers may be copolymeried with one or more other copolymerizable vinyl polymers such as diacetonacrylamide, vinylnaphthalene, 4-vinylbenzyl alcohol, vinyl benzoate, vinyl propionate, vinyl caproate, vinyl chloride, vinyl oleate dimethyl maleate, maleic acid anhydride, dimethylfumarate, vinyl sulphonic acid, vinyl sulphonamide, methyl vinyl sulphonate, N-vinyl pyrrolidone, vinyl pyridine, divinylbenzene, vinyl acetate, vinyl versatate, acrylic acid, methacrylic acid, N-methylmethacrylamide, acrylonitrile, methacrylonitrile, acrylamide or N-(isobutoxymethyl)-acrylamide.

One or more of the aforementioned monomers are optionally reacted with 0 to 10%, preferably 0 to 5%, of a copolymerizable, polyfuictional cross-linking agent, and/or with 0 to 10%, preferably 0 to 5%, of a copolymerizable polyfinctional graft cross-linking agent based on the total weight of the core. If a cross-linking monomer is used, it is preferably used in a proportion of 0.05 to 5%, more preferably of 0.1 to 1%, based on the total weight of the core monomers. Cross-linking monomers are well known and generally are polyethylenically unsaturated, where the ethylenically unsaturated groups have virtually the same reactivity as divinylbenzene, trivinylbenzene, 1,3-or 1,4-triol acrylates or triol methacrylates, glycol-di- or trimethacrylates or -acrylates, such as ethylene glycol dimethacrylate or -diacrylate, propylene glycol dimethacrylate or -diacrylate, 1,3-or 1,4-butylene glycol dimethacrylate or most preferably 1,3-or 1,4-butylene glycol diacrylate. If a graft cross-linking monomer is used, it is preferably used in a proportion of 0.1 to 5%, more preferably of 0.5 to 2.5%, based on the total weight of the core monomers. Graft cross-linking monomers are well known and in general are polyethylenically unsaturated monomers, which have adequately low reactivity of the unsaturated groups, so significant remaining non-saturation is possible, which remains in the core following its polymerization. Preferred graft cross-linking agents are copolymerizable allyl, methallyl or crotyl esters of α,β-ethylenically unsaturated carboxylic acids or dicarboxylic acids, such as allyl methacrylate, allyl acrylate, diallyl maleate and allyl acryloxypropionate, most preferably allyl methacrylate.

The polymeric particles most preferably contain a core of rubbery alkyl acrylate polymers, the alkyl group having 2 to 8 carbon atoms, optionally copolymerized with 0 to 5% cross-linking agents and 0 to 5% graft cross-linking agents, based on the total weight of the core. The rubbery alkyl acrylate is preferably copolymerized with up to 50% of one or more copolymerizable vinyl monomers, for example those mentioned above. Suitable cross-linking and graft cross-linking monomers are well known to the person skilled in the art in the specialist area and those, such as are described in EP-A 0 269 324, are preferred.

The core of the polymeric particles may contain residual oligomeric material, which was used in the polymerization process in order to swell the polymer particles, but an oligomeric material of this type has an adequate molecular weight to prevent its diffusion or to prevent it being extracted during processing or use.

The polymeric particles contain one or more shells. This one shell or this plurality of shells is preferably produced from a vinyl homopolymer or vinyl copolymer. Suitable monomers for producing the shell(s) are listed in U.S. Pat. No. 4,226,752, column 4, lines 20 to 46, incorporated herein by reference. A shell or a plurality of shells is preferably a polymer of a methacrylate, acrylate, vinylarene, vinyl carboxylate, acrylic acid and/or methacrylic acid.

Preferred acrylates and methacrylates are alkyl acrylates or alkyl methacrylates, which preferably contain 1 to 18, more preferably 1 to 8, most preferably 2 to 8 carbon atoms in the alkyl group, such as methyl, ethyl, n-propyl, isopropyl, n-butyl, isobutyl or tert.-butyl, 2-ethylhexyl or the hexyl, heptyl or octyl groups. The alkyl group may be branched or linear. The preferred alkyl acrylate is ethyl acrylate. Other usable acrylates and methacrylates are those which were stated above for the core, preferably 3-hydroxypropyl methacrylate. The most preferred alkyl methacrylate is methyl methacrylate.

Preferred vinylarenes are styrene or α-methylstyrene, optionally substituted at the aromatic ring with an alkyl group, such as methyl, ethyl or tert.-butyl or with a halogen, such as chlorostyrene.

A preferred vinyl carboxylate is vinyl acetate.

The at least one shell preferably contain(s) at least 15%, more preferably at least 25%, most preferably at least 40% of a polymerized methacrylate, acrylate or monovinylarene and 0 to 85%, more preferably 0 to 75%, most preferably 0 to 60% (the percents being relative to the weight of the shell(s) of one or more vinyl comonomers, such as other alkyl methacrylates, aryl methacrylates, alkyl acrylates, aryl acrylates, alkyl- and arylacrylamides, acrylonitrile, methacrylonitrile, maleimide and/or alkyl and aryl acrylates and methacrylates, which are substituted with one or more substituents, such as halogen, alkoxy, alkylthio, cyanoalkyl or amino. Examples of suitable vinyl comonomers are given above. Two or more monomers may be copolymerized.

The shell polymer may contain a cross-linking agent and/or a graft cross-linking agent of the type, as given above with reference to the core polymer.

The shell polymers preferably make up from 5 to 40% (more preferably from 15 to 35%) of the total weight of the particle.

The polymeric particles contain at least 15%, preferably from 20 to 80%, more preferably from 25 to 60%, most preferably from 30 to 50% of a polymerized alkyl acrylate or methacrylate, based on the total weight of the polymer. Preferred alkyl acrylates and methacrylates are given above. The alkyl acrylate or alkyl methacrylate constituent may be present in the core and/or in the shell/shells of the polymer particles. Homopolymers of an alkyl acrylate or methacrylate in the core and/or the shell/shells are usable, however, an alkyl (meth)acrylate is preferably copolymerised with one or more other types of alkyl(meth)acrylates and/or one or more other vinyl polymers, preferably with the ones listed above. The polymeric particles most preferably contain b) a core of a poly-(butyl acrylate) and a shell or plurality of shells of poly(methyl methacrylate).

The polymeric particles are used to provide the thermoplastic polymers with light diffusing properties. The refractive index (n) of the core and the at least one shell of the polymeric particles b) is preferably within ±0.25 units, more preferably within ±0.18 units, most preferably within ±0.12 units of the refractive index of the thermoplastic polymers. The refractive index (n) of the core and the at least one shell is preferably not closer than ±0.003 units, more preferably not closer than ±0.01 units, most preferably not closer than ±0.05 units to the refractive index of the thermoplastic polymer. The refractive index is measured in accordance with the standard ASTM D 542-50 and/or DIN 53 400.

The polymeric particles generally have an average particle diameter of at least 0.5 micrometres, preferably at least 2 micrometres, more preferably from 2 to 50 micrometres, most preferably from 2 to 15 micrometres. “Average particle diameter” is taken to mean the number average. Preferably at least 90%, more preferably at least 95% of the polymeric particles have a diameter greater than 2 micrometres. The particle diameter may be determined by known methods. The polymeric particles are preferably a free-flowing powder.

The polymeric particles may be produced in a known manner. In general, at least one monomer component of the core polymer is subjected to emulsion polymerization with the formation of emulsion polymer particles. The emulsion polymer particles are caused to swell with the same or one or more other monomer components of the core polymer, and the monomer(s) are polymerized within the emulsion polymer particles. The swelling and polymerization stages may be repeated until the particles have grown to the desired core size. The core polymer particles are suspended in a second aqueous monomer emulsion, and a polymer shell of the monomer(s) is polymerized onto the polymer particles in the second emulsion. The shell or a plurality of shells may be polymerized on the core polymer. The production of core/shell polymer particles is described in EP-A 0 269 324 and in the U.S. Pat. Nos. 3,793,402 and 3,808,180 incorporated herein by reference.

The multilayered sheets of the invention may be produced either by injection molding or by extrusion. Large-area sheets are generally produced by conventional extrusion. The polycarbonates used for extrusion with a high melt viscosity are generally processed at melt temperatures from 240 to 320° C., and the cylinder temperatures of the plasticizing cylinder and the die temperatures are adjusted accordingly.

Multilayered sheets may be produced by conventional co-extrusion as disclosed for example in EP-A 0 110 221 and EP-A 0 110 238.

Both layers of the inventive sheet may contain additives, such as, for example, UV absorbers and other conventional processing aids, in particular, mold release agents and free-flow agents and the conventional stabilizers for polycarbonates, in particular heat stabilizers and antistatics, colorants, optical brighteners and inorganic pigments. Different additives or concentrations of additives may be present in each layer in this case.

In particular, coextruded layer may also contain mold release agents as well as UV absorbers.

Suitable stabilizers are for example, phosphines, phosphites or Si-containing stabilizers and further compounds described in EP-A 0 500 496. Mentioned by way of example are triphenyl phosphites, diphenylalkyl phosphites, phenyldialkyl phosphites, tris-(nonylphenyl) phosphite, tetrakis-(2,4-di-tert.-butylphenyl)-4,4′-biphenylene-diphosphonite, bis(2,4-dicumylphenyl)pentaerythritoldiphosphite and triaryl phosphite. Particularly preferred are triphenylphosphine and tris-(2,4-di-tert.-butylphenyl) phosphite.

Suitable mold release agents are, for example, esters or part esters of one to six valent alcohols, in particular of glycerol, pentaerythritol or Guerbet alcohols.

Monovalent alcohols are, for example, stearyl alcohol, palmityl alcohol and Guerbet alcohols, a divalent alcohol is, for example glycol, a trivalent alcohol is, for example, glycerol, tetravalent alcohols are, for example pentaerythritol and mesoerythritol, pentavalent alcohols are, for example, arabitol, ribitol and xylitol, hexavalent alcohols are, for example, mannitol, glucitol (sorbitol) and dulcitol.

The esters are preferably the monoesters, diesters, triesters, tetraesters, pentaesters and hexaesters or their mixtures, in particular statistical mixtures, of saturated aliphatic C₁₀ to C₃₆ monocarboxylic acids, and optionally hydroxy-monocarboxylic acids, preferably with saturated, aliphatic C₁₄ to C₃₂ monocarboxylic acids and optionally hydroxy-monocarboxylic acids.

The commercially available fatty acid esters, in particular of pentaerythritol and glycerol, may contain <60% different part esters due to the production process.

Saturated aliphatic monocarboxylic acids containing 10 to 36 C atoms are, for example, capric acid, lauric acid, myristic acid, pamitic acid, stearic acid, hydroxystearic acid, arachidic acid and behenic acid, lignoceric acid, cerotic acid and montanic acid.

Preferred saturated aliphatic monocarboxylic acids containing 14 to 22 C atoms are, for example, myristic acid, palmitic acid, stearic acid, hydroxystearic acid, arachidic acid and behenic acid.

Particularly preferred are saturated aliphatic monocarboxylic acids, such as palmitic acid, stearic acid and hydroxystearic acid.

The saturated aliphatic C₁₀ to C₃₆ carboxylic acids and the fatty acid esters may be produced by known methods. Examples of pentaerythritol fatty acid esters are the above-mentioned particularly preferred monocarboxylic acids.

Esters of pentaerythritol and glycerol with stearic acid and palmitic acid are particularly preferred.

Esters of Guerbet alcohols and glycerol with stearic acid and palmitic acid and optionally hydroxystearic acid are also particularly preferred.

Examples of suitable antistatics are cationic compounds, for example quaternary ammonium, phosphonium or sulphonium salts, anionic compounds, for example alkyl sulphonates, alkyl sulphates, alkyl phosphates, carboxylates in the form of alkali or alkaline-earth metal salts, non-ionic compounds, for example polyethylene glycol esters, polyethylene glycol ethers, fatty acid esters, ethoxylated fatty amines. Preferred antistatics are non-ionic compounds.

### EXAMPLES

The 2.0 mm solid sheets presented in Examples 1 to 4 were produced by coextrusion. Compounding was carried out using a conventional twin-screw extruders at processing temperatures of 240 to 330° C.

In coextrusion of the exemplified sheets the screw length of the main extruder was 33D and a diameter of 70 mm with degassing. The length of the screw of the coextruder for applying the outer layer was 25 D and its diameter was 35 mm. The width of the coextrusion sheet die was 800 mm. The apparatus further included a smoothing calender, a roller conveyor, a take-off mechanism, a device for cutting to length (saw) and a depositing table.

The equipment and procedure used in preparing the exemplified sheets were conventional.

### Example 1

The following composition containing polycarbonate, transparent polymeric particles and a thermal stabilizer was produced containing:

Polycarbonate: Makrolon® OD 2015 from Bayer MaterialScience AG, Leverkusen, Germany, in a proportion of 99.2% by weight.

Transparent polymeric particles: core/shell particles having butadiene/styrene core and a methylmethacrylate shell, Paraloid® EXL 5137 from Rohm & Haas with a particle size of 2 to 15 μm and mean particle size of 8 μm in a proportion of 0.7% by weight.

Heat stabilizer: triphenylphosphine in a proportion of 0.1% by weight.

A 2.0 mm solid sheet was extruded from the above composition along with a coextruded layer on one of its surfaces. The coextruded layer had the following composition:

Polycarbonate: same as above in a proportion of 94.75% by weight. UV absorber: Hostavin® B-CAP from Clariant in a proportion of 5.0% by weight.

Mold release agent: pentaerythritoltetrastearate (PETS, Loxiol®) from Cognis, Dusseldorf, Germany, in a proportion of 0.25% by weight.

### Example 2

A compound having the following composition was produced:

Polycarbonate: Makrolon® OD 2015 in a proportion of 99.2% by weight. Transparent polymeric particles: Paraloid® EXL 5137 in a proportion of 0.7% by weight.

Heat stabilizer: triphenylphosphine in a proportion of 0.1% by weight.

A 2.0 mm solid sheet was extruded from the above composition along with a coextruded layer on one of its surfaces. The coextruded layer had the following composition:

Polycarbonate: Makrolon® OD 2015 in a proportion of 94.75% by weight. UV absorber: Tinuvin® 360 from Ciba Specialities, in a proportion of 5.0% by weight.

Mold release agent: pentaerythritoltetrastearate in a proportion of 0.25% by weight.

### Example 3

A compound having the following composition was produced:

Polycarbonate: Makrolon® OD 2015 in a proportion of 97.5% by weight.

Transparent polymeric particles: Paraloid® EXL 5137 in a proportion of 2.4% by weight.

Heat stabilizer: triphenylphosphine in a proportion of 0.1% by weight.

A 2.0 mm solid sheet was coextruded from this composition along with a layer on one of its sides. The coextruded layer had the following composition:

Polycarbonate: Makrolon® OD 2015 in a proportion of 94.75% by weight.

UV absorber: Hostavin® B-CAP in a proportion of 5.0% by weight.

Mold release agent: pentaerythritoltetrastearate in a proportion of 0.25% by weight.

### Example 4

A compound having the following composition was produced:

Polycarbonate: Makrolon® OD 2015 in a proportion of 97.5% by weight. Transparent polymeric particles: Paraloid®0 EXL 5137 in a proportion of 2.4% by weight.

Heat stabilizer: triphenylphosphine in a proportion of 0.1% by weight.

A 2.0 mm solid sheet was coextruded from this composition along with a layer on one of its sides having the following composition:

Polycarbonate: Makrolon® OD 2015 in a proportion of 94.75% by weight. UV absorber: Tinuvin® 360 in a proportion of 5.0% by weight.

Mold release agent: pentaerythritoltetrastearate in a proportion of 0.25% by weight.

The sheets described in Examples 1 to 4 were examined for their optical properties according to the following standards and using the following measuring equipment:

The measurements to determine the yellowness index (yellowness index YI (D65, C2°), ASTM E313), the x, y color indices (D65, C2°, CIE standard color table) and the L, a, b color indices (D65, C2°, CIELAB color system, DIN 6174) were carried out using an Ultra Scan XE from Hunter Associates Laboratory, Inc. A Hazegard Plus from Byk-Gardner was used for the haze determination (ASTM D 1003). The half-value angle HW was determined as a measure of the strength of the light-diffusing effect using a Goniophotometer to DIN 58161. The brightness measurements were carried out using a backlight unit (BLU) from DS LCD (LTA320W2-L02, 32″ LCD TV panel) with the aid of a Topcon Luminance Colorimeter BM-7 from Topcon Technohouse Corp.

To determine the light transmission (Ty (D6510°)) and the light reflection (Ry (D6510°) over a white background) an Ultra Scan XE from Hunter Associates Laboratory, Inc. was used. The measurements for determining the yellowness index (yellowness index YI (D65, C2°), ASTM E313), the x, y color indices (D65, C2°, CIE standard color table) and the L, a, b color indices (D65, C2°, CIELAB color system, DIN 6174) were moreover carried out with this equipment. A Hazeguard Plus from Byk-Gardner was used for the haze determination (ASTM D 1003). The brightness measurements were carried out using a backlight unit (BLU) from DS LCD, (LTA320W2-L02, 32″ LCD TV panel) with the aid of a Topcon Luminance Colorimeter BM-7 from Topcon Technohouse Corp. The color indices x and y were also determined using the backlight unit with the same measuring equipment. The standard diffuser sheet was removed in the process and replaced in each case by the 2 mm solid sheets produced in Examples 1 to 4.

The results of the measurements are compiled in the following Table 1.

TABLE 1
Optical data

| | Invention | Comparison | Invention | Comparison |
|---|---|---|---|---|
| | Example 1 | Example 2 | Example 3 | Example 4 |
| HW [°] | 28 | 28 | 57 | 57 |
| YI (C2°) | −2.19 | 1.64 | −16.11 | −1.21 |
| L* (C2°) | 87.89 | 86.01 | 80.94 | 79.00 |
| a* (C2°) | 0.35 | −0.04 | −0.36 | −1.53 |
| b* (C2°) | −1.19 | 0.80 | −6.84 | 0.08 |
| Haze [%] | 100 | 100 | 100 | 100 |
| Brightness [cd/m²] | 6400 | 6300 | 6050 | 5900 |
| without films | | | | |
| Brightness [cd/m²] | 8800 | 8700 | 8800 | 8550 |
| with films | | | | |
| x color index with | 0.2509 | 0.2522 | 0.2521 | 0.2545 |
| films | | | | |
| y color index with | 0.2390 | 0.2408 | 0.2450 | 0.2482 |
| films | | | | |

From the optical data listed in Table 1 for the various diffuser plates, the clear advantage of the diffuser plates, which contain Hostavin® B-CAP as the UV absorber in the UV coextrusion layer, may clearly be seen (Examples 1 and 3). Thus, for example, the pair Example 1 -Example 2 shows a clear difference in brightness on a backlight unit with the same diffusion force at a half-value angle of 28°. The brightness in Example 1 (Hostavin® B-CAP in the coextrusion layer) is 100 cd/m² higher than in Example 2 (Tinuvin® 360 in the coextrusion layer). In the second pair Example 3 -Example 4, this surprising result may also be seen. Although, here too, the diffusion force is the same at a half-value angle of 57°, Example 3 (Hostavin® B-CAP in the coextrusion layer) shows a still greater brightness advantage of 250 cd/m² compared to Example 4 (Tinuvin® 360 in the coextrusion layer).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A multilayer sheet, comprising at least one base layer (B) and at least one outer layer (A) wherein said (B) comprise a composition, containing (B1) 80 to 99.99% relative to the weight of (B) of a transparent thermoplastics material and (B2) 0.01 to 20% relative to the weight of (B) of a transparent polymeric particles, with the proviso that the refractive index of said (B1) is different from that of (B2), and wherein said (A) comprise a composition containing 90 to 99% relative to the weight of (A) of a transparent polycarbonate and 1 to 10% relative to the weight of (A) of a UV absorber conforming to formula (I) 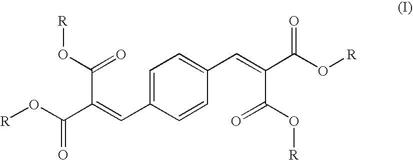
wherein R represents alkyl.

2. The multilayer solid sheet according to claim 1, wherein R represents ethyl.

3. The multilayer solid sheet according to claim 1 wherein the thermoplastics material is a member selected from the group consisting of polycarbonates, copolyester carbonates, polyesters, copolyesters, polymethyl methacrylate, polyethyl methacrylate and styrene-acrylonitrile copolymer.

4. The multilayer solid sheet according to claim 1, wherein the thermoplastics material is polycarbonate or polyester carbonate.

5. The multilayer solid sheet according to claim 1 comprising in sequence layers A, B and A.

6. The multilayer solid sheet according to claim 1 wherein the transparent polymeric particles are graft polymers having core-shell morphology and a mean particle size of 1 to 100 μm.

7. The multilayer solid sheet according to claim 1 wherein base layer B further contains a lubricant.

8. The multilayer solid sheet according to claim 1 wherein each of said A and said B further contain an optical brightener.

9. The multilayer solid sheet according to claim 1 wherein said layer B is 10 to 100 μm thick.

10. The multilayer solid sheets according to claim 1 having a thickness of 0.1 to 4 mm.

11. A flat screen comprising a diffuser comprising the multilayer solid sheet according to claim 1.
